(19) United States
(12) Patent Application Publication
(10) Pub. No.: US 2001/0021615 A1
(43) Pub. Date: Sep. 13, 2001

(54) Printed coated textile based on an epichlorohydrin elastomer

(76) Inventor: Guy Bauts, Tournai (BE)

Correspondence Address: YOUNG & THOMPSON, 745 SOUTH 23RD STREET 2ND FLOOR, ARLINGTON, VA, 22202

(21) Appl. No.: 09/758,208

(22) Filed: Jan. 12, 2001

Related U.S. Application Data
(60) Provisional application No. 60/201,744, filed on May 4, 2000.

(30) Foreign Application Priority Data
Jan. 12, 2000 (FR) 00 00358

(51) Int. Cl. B32B 3/00; B32B 5/02; B32B 9/00

(52) U.S. Cl. 442/59

(57) ABSTRACT

The present invention relates to a coated textile having printed patterns, characterized in that it comprises a textile underlayer forming a backing and combined with a coating layer based on a vulcanized epichlorohydrin elastomer, the said coating layer having one or more printed patterns on its surface which is not bonded to the textile underlayer.

It also relates to a process for producing it.

It applies more particularly to the manufacture of printed coated tablecloths.

The present invention relates to printed coated textiles, in which the coating layer is based on an epichlorohydrin elastomer as well as to a process for producing them.

Currently available printed coated fabrics, for example for the production of tablecloths or other articles in the field of tableware, generally have a coating layer of PVC (polyvinyl chloride) and/or halogenated polymers, particularly of fluoropolymers.

Nevertheless, these coated fabrics are not very flexible and have insufficient ageing resistance, becoming stiff and brittle but also sticky to touch. In particular, they have very poor weather and ultraviolet resistance.

Moreover, these fabrics exhibit poor resistance to food stains which remain more and more pronounced over time and become more and more difficult to remove. At the same time, they may lose their colours or their printing patterns, especially with cleaning or due to the effect of light, or may even give rise to yellowing.

The PVC-coated fabrics furthermore exhibit poor heat resistance so that they become damaged, for example when hot dishes are placed on them.

One object of the present invention is to provide coated textiles able to bear printed patterns or decorations, which can be used in particular in the field of tableware and do not have the abovementioned drawbacks.

Another object of the invention is to provide particularly flexible coated textiles which keep their flexibility with use or with storage, as well as with continual cleaning.

Another object of the invention is also to provide a coated textile having satisfactory “printability” characteristics allowing, in particular, the printing of patterns or decorations placed, which are resistant to ageing, particularly over time, with respect to light rays, cleaning, heat, etc.

Another object of the invention is also to provide a process for the production of such printed coated textiles which is simple and inexpensive.

For this purpose, the subject of the invention is a coated textile having printed patterns, characterized in that it comprises a textile underlayer forming a backing and combined with a coating layer based on a vulcanized epichlorohydrin elastomer, the said coating layer having one or more printed patterns on its surface which is not bonded to the textile underlayer.

The invention also provides a process for the production of the above printed coated textile, characterized in that:

the process starts with a textile forming a backing;

a coating layer, based on an epichlorohydrin, is deposited on the said backing textile;

the desired pattern(s) or decoration(s) are printed;

the resulting assembly is vulcanized; and

optionally, a protective varnish is deposited.

The printed coated textile according to the invention is described in greater detail below.

According to the invention, the term “printed” should be understood to mean that patterns or decorations are applied to the surface of the coating layer of the coated textile, in a discontinuous and varied manner, generally using inks of the modified polyurethane and/or acrylic type, as opposed to homogeneous coloration throughout the medium leading to relatively uniformly coloured materials.

The inventors have quite surprisingly discovered that, by applying a coating based on an epichlorohydrin elastomer to a backing textile, the printing of one or more patterns—or decorations can then be produced by the techniques of transfer printing or heliogravure printing, especially using an ink of the possibly modified polyurethane and/or acrylic type.

Apart from the aforementioned epichlorohydrin component, the coating layer includes various additives known per se for modifying/improving the mechanical properties, the light resistance, the heat resistance, etc., such as plasticizers, fillers, UV or heat stabilizers and a vulcanizing agent.

The composition of the coating layer is typically as defined below:

| | | |
|---|---|---|
| epichlorohydrin | 100 | parts by weight |
| ethylene-vinyl acetate | 5 to 30 | parts by weight |
| copolymer (EVA) | | |
| fillers | 30 to 80 | parts by weight |
| plasticizers | 5 to 15 | parts by weight |
| UV and heat stabilizers | 1 to 3 | parts by weight |
| vulcanizing agent | 1 to 6 | parts by weight |
| colorants | 10 to 40 | parts by weight |

The textile layer forming a backing may comprise or consist of a woven, of a nonwoven or of a mesh, a woven or nonwoven being preferred. The textile may equally well be a natural, an artificial or a synthetic textile.

The aforementioned coating composition is applied to the textile backing by calendering.

Next, the printing proper of one or more desired patterns or decorations on the resulting coated textile is carried out.

For this purpose, two methods can be used:

The printing may be carried out by transfer. In this case, the pattern or patterns is(are) produced beforehand on a transfer paper using preparatory techniques known per se.

The printed paper is then joined to the coated textile using pressure and heat. The temperature is generally about 100° C. and the pressure about 1 bar.

The pattern or patterns to be printed is(are) brought into contact with the coating layer and the paper is removed after the assembly has been cooled.

The printing may also be carried out by heliogravure.

In this case, the coated textile is printed by passing it between metal rollers bearing the etched pattern or patterns in the form of hollows filled with ink.

The printed coated textile resulting from either of these operations is then vulcanized. Depending on the case, this vulcanization step may be carried out hot, continuously or discontinuously, optionally under pressure.

The final printed coated textile may then be protected by a varnish, especially of the acrylic type. Depending on the desired effect, the protective varnish may be colourless or coloured, but it is translucent in order to reveal the printed pattern or patterns. In particular, it is a varnish having anti-food-stain properties.

The printed coated textile according to the invention is, especially, very flexible and exhibits good ageing, weather and UV resistance.

It is easily cleanable and the printing applied exhibits good adhesion to the textile backing and good resistance over time, especially when exposed to weather and to successive washing operations.

Moreover, it exhibits good heat resistance and thus withstands contact with, for example, hot dishes.

In addition, no sticky feel is found during its use.

The printed coated textile according to the invention exhibits good liquid-impermeability characteristics.

The invention also relates to articles comprising a printed coated textile as defined above and applies more particularly to the manufacture of printed coated tablecloths or other articles intended as tableware.

The invention will now be illustrated with the aid of an example which must not be regarded as being limiting.

### EXAMPLE

The various phases in the production of a printed coated tablecloth are as follows:

1) Use of a 75/25 cotton polyester backing; weight 75 g/M².

2) Calendering of a 180 g/m² film of elastomer onto the backing—calendering temperature 100° C. Powder-coating of the coating using calcium stearate.

3) Printing. Use of a printed transfer paper Pressure lamination at 100° C. of the transfer paper with the calendered woven. The printing is in contact with the elastomer.

4) Varnishing.

Heliogravure varnishing using a varnish based on modified acrylic-polyurethane resins in order to make the article anti-staining. Wet deposition of 20 g/m² of a solution having a 15% solids content. Drying at approximately 80° C.

5) Vulcanization Continuous vulcanization in a tunnel. Speed: 5 meters per minute. Tunnel temperature: 180° C.

1. Coated textile having printed patterns, characterized in that it comprises a textile underlayer forming a backing and combined with a coating layer based on a vulcanized epichlorohydrin elastomer, the said coating layer having one or more printed patterns on its surface which is not bonded to the textile underlayer.

2. Coated textile having printed patterns according to claim 1, characterized in that the textile underlayer comprises or consists of a woven, a nonwoven or a mesh, preferably a woven or a nonwoven.

3. Coated textile having printed patterns according to claim 1 or 2, characterized in that it is provided with a protective varnish applied to the printed coating layer, preferably a protective varnish having anti-stain properties.

4. Process for the production of a coated textile having printed patterns according to any one of claims 1 to 3, characterized in that:
the process starts with a textile forming a backing;
a coating layer, based on an epichlorohydrin, is deposited on the said backing textile;
the desired pattern(s) or decoration(s) are printed;
the resulting assembly is vulcanized; and
optionally, a protective varnish is deposited.

5. Process according to claim 4, characterized in that the textile forming a backing comprises or consists of a woven, a nonwoven or a mesh, preferably a woven or a nonwoven.

6. Process according to claim 4 or 5, characterized in that the composition of the coating layer is as follows:

| | | |
|---|---|---|
| epichlorohydrin | 100 | parts |
| ethylene-vinyl acetate | 5 to 30 | parts |
| copolymer | | |
| fillers | 30 to 80 | parts |
| plasticizers | 5 to 15 | parts |
| UV and heat stabilizers | 1 to 3 | parts |
| vulcanizing agent | 1 to 6 | parts |
| colorants | 10 to 40 | parts |

7. Process according to any one of claims 4 to 6, characterized in that the coating layer is applied by calendering it onto the textile backing.

8. Process according to any one of claims 4 to 7, characterized in that the printing of the pattern(s) or decoration(s) is carried out by transfer.

9. Process according to any one of claims 4 to 7, characterized in that the printing of the pattern(s) or decoration(s) is carried out by heliogravure.

10. Process according to claim 8 or 9, characterized in that the printing is carried out using inks of the possibly modified polyurethane and/or acrylic type.

11. Articles comprising a coated textile having printed patterns according to any one of claims 1 to 10.

12. Articles according to claim 11, characterized in that they consist of tablecloths.
